(19) United States
(12) Patent Application Publication
(10) Pub. No.: US 2025/0002634 A1
(43) Pub. Date: Jan. 2, 2025

(54) THERMOPLASTIC POLYURETHANE RESIN USED FOR PREPARING CAR WRAP FILM

(71) Applicant: NAN YA PLASTICS CORPORATION, TAIPEI (TW)

(72) Inventors: TE-CHAO LIAO, TAIPEI (TW); HAN-CHING HSU, TAIPEI (TW); CHEN-WEI CHANG, TAIPEI (TW)

(21) Appl. No.: 18/460,663

(22) Filed: Sep. 4, 2023

(30) Foreign Application Priority Data
Jun. 30, 2023 (TW) 112124490

(51) Int. Cl. C08G 18/12; C08G 18/32; C08G 18/42; C08J 5/18; C08K 5/05; C08K 5/29

(52) U.S. Cl. CPC C08G 18/12; C08G 18/3206; C08G 18/4277; C08J 5/18; C08K 5/05; C08K 5/29

(57) ABSTRACT

A thermoplastic polyurethane resin used for preparing a car wrap film is formed from a reaction mixture through a polymerization reaction. The reaction mixture includes: an isocyanate material, a polyol material, and a chain extender. The isocyanate material does not have any benzene ring in its chemical structure. The isocyanate material is selected from the group consisting of 4,4′-diisocyanato dicyclohexylmethane (H₁₂MDI), hexamethylene diisocyanate (HDI), and isophorone diisocyanate (IPDI). The polyol material is selected from the group consisting of polycaprolactone polyol and polyether polyol. The chain extender is a glycol chain extender.

### CROSS-REFERENCE TO RELATED PATENT APPLICATION

This application claims the benefit of priority to Taiwan Patent Application No. 112124490, filed on Jun. 30, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a thermoplastic polyurethane resin, and more particularly to a thermoplastic polyurethane resin used for preparing a car wrap film.

### BACKGROUND OF THE DISCLOSURE

A conventional thermoplastic polyurethane resin (TPU material) used for preparing a car wrap film is prone to yellowing over time, and is subject to degradation of physical properties due to hydrolysis of the TPU material. After coating, a finished product of the conventional thermoplastic polyurethane resin tends to have crystal points and has poor transparency, such that the quality of the car wrap film is not ideal.

### SUMMARY OF THE DISCLOSURE

In response to the above-referenced technical inadequacies, the present disclosure provides a thermoplastic polyurethane resin used for preparing a car wrap film.

In order to solve the above-mentioned problems, one of the technical aspects adopted by the present disclosure is to provide a thermoplastic polyurethane resin used for preparing a car wrap film, and the thermoplastic polyurethane resin is formed from a reaction mixture through a polymerization reaction. The reaction mixture includes an isocyanate material, a polyol material, and a chain extender. The isocyanate material does not have any benzene ring in its chemical structure, and the isocyanate material is at least one material selected from a group consisting of 4,4′-diisocyanato dicyclohexylmethane (H₁₂MDI), hexamethylene diisocyanate (HDI), and isophorone diisocyanate (IPDI). The polyol material is at least one material selected from a group consisting of polycaprolactone polyol and polyether polyol. The chain extender is a glycol chain extender.

In one of the possible or preferred embodiments, the isocyanate material includes a first isocyanate component and a second isocyanate component, the first isocyanate component is 4,4′-diisocyanato dicyclohexylmethane (H₁₂MDI), and the second isocyanate component is at least one of hexamethylene diisocyanate (HDI) and isophorone diisocyanate (IPDI).

In one of the possible or preferred embodiments, based on a total weight of the first isocyanate component and the second isocyanate component being 100%, a first weight ratio of the first isocyanate component ranges from 70% to 98%, and a second weight ratio of the second isocyanate component ranges from 2% to 30%.

In one of the possible or preferred embodiments, the polyol material is further defined as the polycaprolactone polyol, which is formed by polymerizing low molecule diols and caprolactone monomers. Each of the low molecule diols is a diol having a carbon number ranging from C2 to C8.

In one of the possible or preferred embodiments, each of the low molecule diols is 1,6-hexanediol, and a number average molecular weight of the polyol material is between 1,000 g/mole and 5,000 g/mole. The chain extender is 1,4-butanediol.

In one of the possible or preferred embodiments, a NCO/OH equivalent ratio of an isocyanate group (—NCO) of the isocyanate material relative to a hydroxyl group (—OH) of the polyol material is between 0.998 and 1.015.

In one of the possible or preferred embodiments, the reaction mixture further comprises: an anti-hydrolysis agent and a chain terminator, the anti-hydrolysis agent is carbodiimide, and the chain terminator is a long-chain fatty alcohol having a carbon number ranging from C12 to C18.

In one of the possible or preferred embodiments, the chain terminator is at least one material selected from a group consisting of stearyl alcohol, lauryl alcohol, and oleic alcohol.

In one of the possible or preferred embodiments, based on a total weight of the reaction mixture being 100 parts by weight, an amount of the isocyanate material is between 20 parts by weight and 60 parts by weight, an amount of the polyol material is between 20 parts by weight and 60 parts by weight, an amount of the chain extender is between 5 parts by weight and 20 parts by weight, an amount of the anti-hydrolysis agent is between 0.1 parts by weight and 1 part by weight, and an amount of the chain terminator is between 0.01 parts by weight and 0.3 parts by weight.

In one of the possible or preferred embodiments, the thermoplastic polyurethane resin has a melt flow index (MI) between 1 g/10 min and 5 g/10 min measured at 200° C.

Therefore, in the thermoplastic polyurethane resin used for preparing the car wrap film provided by the present disclosure, through material selection and material cooperation of the isocyanate material and the polyol material, technical inadequacies of a conventional TPU material (such as yellowing over time, degradation of physical properties due to hydrolysis, and occurrence of crystal points and poor transparency after coating) can be effectively improved. Accordingly, the quality of the car wrap film can be enhanced.

These and other aspects of the present disclosure will become apparent from the following description of the embodiment taken in conjunction with the following drawings and their captions, although variations and modifications therein may be affected without departing from the spirit and scope of the novel concepts of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### [Thermoplastic Polyurethane Resin]

An embodiment of the present disclosure provides a thermoplastic polyurethane resin, and more particularly provides a thermoplastic polyurethane resin used for preparing a car wrap film.

The thermoplastic polyurethane resin of the embodiment of the present disclosure is formed from a reaction mixture through a polymerization reaction. The reaction mixture includes: an isocyanate material, a polyol material, a chain extender, an anti-hydrolysis agent, and a chain terminator.

It should be noted that, in the present embodiment, the reaction mixture can selectively include an ultraviolet (UV) absorber, a photo-stabilizer, other auxiliary additives (e.g., an antioxidant), and/or other solvents, but the present disclosure is not limited thereto.

Based on a total weight of the reaction mixture being 100 parts by weight, an amount of the isocyanate material is between 20 parts by weight and 60 parts by weight, preferably between 25 parts by weight and 55 parts by weight, and more preferably between 30 parts by weight and 50 parts by weight. An amount of the polyol material is between 20 parts by weight and 60 parts by weight, preferably between 25 parts by weight and 55 parts by weight, and more preferably between 30 parts by weight and 50 parts by weight. An amount of the chain extender is between 5 parts by weight and 20 parts by weight, preferably between 7 parts by weight and 18 parts by weight, and more preferably between 9 parts by weight and 16 parts by weight. However, the present disclosure is not limited thereto.

Further, an amount of the anti-hydrolysis agent is between 0.1 parts by weight and 1 part by weight, preferably between 0.2 parts by weight and 0.9 parts by weight, and more preferably between 0.3 parts by weight and 0.8 parts by weight. An amount of the chain terminator is between 0.01 parts by weight and 0.3 parts by weight, and preferably between 0.05 parts by weight and 0.2 parts by weight. An amount of the ultraviolet absorber is between 0.1 parts by weight and 0.5 parts by weight, and preferably between 0.2 parts by weight and 0.5 parts by weight. An amount of the light stabilizer is between 0.1 parts by weight and 0.5 parts by weight, and preferably between 0.2 parts by weight and 0.5 parts by weight. The other auxiliary additives and/or the other solvents are the remaining components, but the present disclosure is not limited thereto.

In terms of material selection, the isocyanate material is at least one material selected from a group consisting of 4,4′-diisocyanato dicyclohexylmethane (H₁₂MDI, or referred to as hydrogenated diphenylmethane diisocyanate), hexamethylene diisocyanate (HDI), and isophorone diisocyanate (IPDI).

The chemical structure of 4,4′-diisocyanato dicyclohexylmethane (H₁₂MDI) is represented as follows.

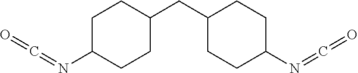 [SMILES: O=C=NC1CCC(CC2CCC(N=C=O)CC2)CC1]

The chemical structure of hexamethylene diisocyanate (HDI) is represented as follows.

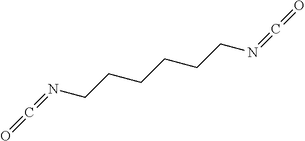 [SMILES: O=C=NCCCCCCN=C=O]

The chemical structure of isophorone diisocyanate (IPDI) is represented as follows.

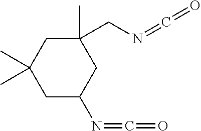 [SMILES: CC1(C)CC(N=C=O)CC(C)(CN=C=O)C1]

It is worth mentioning that, the isocyanate material (i.e., H₁₂MDI, HDI, or IPDI) selected in the embodiment of the present disclosure does not have any benzene ring in its chemical structure.

More specifically, the chemical structure of 4,4′-diisocyanato dicyclohexylmethane (H₁₂MDI) has two cyclohexyl groups. The chemical structure of hexamethylene diisocyanate (HDI) has a single hexamethylene group. The chemical structure of isophorone diisocyanate (IPDI) has a single cyclohexyl group. However, none of the above-mentioned isocyanate materials have the so-called benzene ring in their chemical structures. It should be noted that a carbon-carbon bond (C—C bond) in the benzene ring is a bond between a single bond and a double bond. Furthermore, the isocyanate material selected in the embodiment of the present disclosure can at least effectively improve a yellowing problem occurred to a conventional thermoplastic polyurethane resin over time.

In one exemplary embodiment of the present disclosure, the isocyanate material can be selected from two kinds of isocyanates at the same time. In this way, technical inadequacies in the related art, such as yellowing over time and occurrence of crystal points after coating, can be effectively improved. In addition, scratch resistance and soft tactile feel of the car wrap film can be enhanced.

More specifically, the isocyanate material includes: a first isocyanate component and a second isocyanate component. The first isocyanate component is 4,4′-diisocyanato dicyclohexylmethane (H₁₂MDI), and the second isocyanate component is at least one of hexamethylene diisocyanate (HDI) and isophorone diisocyanate (IPDI).

Based on a total weight of the first isocyanate component and the second isocyanate component being 100%, a first weight ratio of the first isocyanate component (i.e., H₁₂MDI) ranges from 70% to 98%, preferably ranges from 80% to 98%, and more preferably ranges from 86.2% to 94%.

In addition, a second weight ratio of the second isocyanate component (i.e., HDI and/or IPDI) ranges from 2% to 30%, preferably ranges from 2% to 20%, and more preferably ranges from 6% to 13.8%. That is, the first isocyanate component (i.e., H₁₂MDI) is the main isocyanate component, and the second isocyanate component (i.e., HDI and/or IPDI) is the secondary isocyanate component with a small added amount.

It is worth mentioning that the first isocyanate component (i.e., H₁₂MDI) does not have any benzene ring in its chemical structure, but has two symmetrically positioned cyclohexyl groups. As such, the first isocyanate component can not only effectively improve the technical inadequacies in the related art, such as yellowing over time and occurrence of crystal points after coating, but can also maintain physical properties required by the car wrap film.

In addition, since the chemical structure of the first isocyanate component (i.e., H₁₂MDI) is softer than that of aromatic diisocyanate (i.e., MDI) commonly used in the related art, the scratch resistance of the finally formed car wrap film can be effectively improved. Moreover, the second isocyanate component (i.e., HDI and/or IPDI) can also enable the car wrap film to have a softer tactile feel and improved scratch resistance.

Furthermore, the polyol material of the present embodiment is at least one material selected from a group consisting of polycaprolactone (PCL) polyol and polyether polyol. Preferably, the polyol material is the polycaprolactone (PCL) polyol.

The polycaprolactone polyol is formed by polymerizing low molecular diols and caprolactone monomers. Each of the low molecule diols is a diol having a carbon number ranging from C2 to C8.

In one exemplary embodiment of the present disclosure, each of the low molecule diols is a diol having a carbon number of C6. In other words, each of the low molecule diols is preferably 1,6-hexanediol.

In addition, a number average molecular weight (Mn) of the polyol material is between 1,000 g/mole and 5,000 g/mole, and preferably between 1,000 g/mole and 3,000 g/mole.

It is worth mentioning that, under the above-mentioned material parameters, the polycaprolactone polyol enables the finally formed thermoplastic polyurethane resin (i.e., TPU granules) to have better transparency, hydrolysis resistance, and processability.

Furthermore, the low molecule diols are preferably 1,6-hexanediol, and may enable the TPU granules to have better processability as compared with other diols (e.g., 1,4-butanediol). The thermoplastic polyurethane resin of the embodiment of the present disclosure is synthesized by use of the polycaprolactone polyol, which is better than the polyether polyol in terms of physical properties (e.g., light transmittance). In addition, typical polyester polyols have poor hydrolysis resistance, and are thus not considered to be used in the present disclosure.

It is worth mentioning that, in some embodiments of the present disclosure, a NCO/OH equivalent ratio of an isocyanate group (—NCO) of the isocyanate material relative to a hydroxyl group (—OH) of the polyol material is preferably between 0.998 and 1.015, and more preferably between 1.012 and 1.015.

Accordingly, the finally formed thermoplastic polyurethane resin (i.e., the TPU granules) can have a stable change rate of melt flow index (MI).

In some embodiments of the present disclosure, the chain extender is a diol chain extender, and the chain extender is preferably 1,4-butanediol (1,4-BG). An amount of the chain extender is between 5 parts by weight and 20 parts by weight, preferably between 7 parts by weight and 18 parts by weight, and more preferably between 9 parts by weight and 16 parts by weight. The chain extender can effectively improve specific physical properties of the finally formed thermoplastic polyurethane resin, such as hardness, heat resistance, and/or hydrolysis resistance.

In some embodiments of the present disclosure, the anti-hydrolysis agent is preferably carbodiimide.

An amount of the anti-hydrolysis agent is between 0.1 parts by weight and 1 part by weight, preferably between 0.2 parts by weight and 0.9 parts by weight, and more preferably between 0.3 parts by weight and 0.8 parts by weight.

The anti-hydrolysis agent can effectively improve the hydrolysis resistance of the finally formed thermoplastic polyurethane resin.

In some embodiments of the present disclosure, the chain terminator is preferably a long-chain fatty alcohol (i.e., monohydric alcohol) having a carbon number of from C12 to C18. For example, the chain terminator can be selected from the group consisting of stearyl alcohol (a C18 long-chain fatty alcohol), lauryl alcohol (a C12 long-chain fatty alcohol), and oleic alcohol (a C18 long-chain unsaturated fatty alcohol), but the present disclosure is not limited thereto. An amount of the chain terminator is between 0.01 parts by weight and 0.3 parts by weight, and preferably between 0.05 parts by weight and 0.2 parts by weight. The chain terminator is configured to regulate a melt flow index (MI) and a molecular weight of the finally formed thermoplastic polyurethane resin (i.e., the TPU granules).

It is worth mentioning that the melt flow index (MI) of the thermoplastic polyurethane resin is adjusted to be between 1 g/10 min and 5 g/10 min measured at 200° C., preferably between 1.5 g/10 min and 4 g/10 min measured at 200° C., and more preferably between 1.6 g/10 min and 3.1 g/10 min measured at 200° C. A weight average molecular weight (Mw) of the thermoplastic polyurethane resin is between 120,000 g/mol and 280,000 g/mol, preferably between 150,000 g/mol and 250,000 g/mol, and more preferably between 185,000 g/mol and 223,000 g/mol.

It should be noted that the “melt flow index (MI)” mentioned in the present embodiment refers to a weight of the thermoplastic polyurethane resin that passes through a standard die every 10 minutes when measured at a temperature of 200° C. on a melt flow velocimeter. The unit of the melt flow index (MI) is represented as “g/10 min measured at 200° C.”. The melt flow index (MI) represents the fluidity of a resin in a molten state. The larger the melt flow index (MI) is, the smaller the molecular weight of the resin is, and the higher the fluidity of the resin is.

In addition, the molecular weight (i.e., weight average molecular weight, Mw) of the thermoplastic polyurethane resin can be obtained by analyzing the thermoplastic polyurethane resin through a gel permeation chromatography (GPC).

Furthermore, the ultraviolet absorber is configured to improve ultraviolet resistance of the finally formed thermoplastic polyurethane resin (i.e., to improve a QUV level).

In some embodiments of the present disclosure, the ultraviolet absorber is selected from the group consisting of benzotriazoles, benzophenones, and triazines. In a specific application example, the ultraviolet absorber is a UV-328 ultraviolet absorber (i.e., 2-(2H-benzotriazol-2-yl)-4,6-di-tert-pentylphenol), but the present disclosure is not limited thereto. It is worth mentioning that the UV-328 ultraviolet absorber belongs to a phenolic benzotriazole compound.

In some embodiments of the present disclosure, the light stabilizer is a hindered amine light stabilizer (HALS) having a low molecular weight. For example, the light stabilizer is an LS 770 hindered amine light stabilizer (bis(2,2,6,6-tetramethyl-4-piperidyl) sebacate), but the present disclosure is not limited thereto.

According to the material selection and the amount of each component in the thermoplastic polyurethane resin mentioned above, the thermoplastic polyurethane resin (i.e., the TPU granules) can have good performance in the following physical properties.

### [Processability]

After the TPU granules are coated on an object (i.e., a car shell) by an extruder (T-die) for formation of a film (i.e., the car wrap film), an appearance of the film does not have coarse grains or crystal points.

That is, the thermoplastic polyurethane resin has good processability.

### [Light Transmittance]

An injection-molded test piece having a thickness of 2 mm has a visible light transmittance of not less than 90%.

That is, the thermoplastic polyurethane resin has good light transmittance.

### [Weather Resistance]

A thermo-compression-molded test piece having a thickness of 0.2 mm is irradiated by a light source of QUV 340 nm for 1,000 hours, and a ΔE color difference value is not greater than 5 (preferably not greater than 3).

That is, the thermoplastic polyurethane resin is weather resistant (i.e., having the property of not easily yellowing over time). A QUV ultraviolet weather resistance tester can be used as a test instrument, and a test method is carried out according to ASTM G154-16.

### [Hydrolysis Resistance]

A thermo-compression-molded test piece having a thickness of 0.2 mm is stored in an environment where a temperature is 60° C. and a relative humidity is 90 RH % for 28 days, and a tensile strength maintenance rate of the test piece is not less than 80%.

That is, the thermoplastic polyurethane resin has good hydrolysis resistance.

### [Method for Producing Thermoplastic Polyurethane Resin]

The above description relates to material characteristics of the thermoplastic polyurethane resin according to the embodiment of the present disclosure. Another embodiment of the present disclosure further provides a method for producing a thermoplastic polyurethane resin, and the method includes step S110, step S120, and step S130, but the present disclosure is not limited thereto.

Step S110 is to perform a mixing step, which includes: mixing an isocyanate material, a polyol material, a chain extender, an anti-hydrolysis agent, and other minor added ingredients (e.g., a UV absorber and a light stabilizer) in a mixer according to a predetermined usage amount, so as to form a reaction mixture.

Step S120 is to perform a reaction step, which includes: introducing the reaction mixture into an extruder (e.g., a twin-screw extruder), so that the isocyanate material and the polyol material undergo a polymerization reaction; and introducing a chain terminator into the reaction mixture at a rearward section of the extruder, so as to terminate the polymerization reaction and finally form the thermoplastic polyurethane resin.

An extrusion temperature of the extruder can be, for example, between 150° C. and 250° C., so that the polymerization reaction can be sufficiently carried out. However, the present disclosure is not limited thereto.

Step S130 is to perform a granulation step, which includes: dicing the thermoplastic polyurethane resin in a water phase environment, so as to enable the thermoplastic polyurethane resin to take the form of colloidal particles (i.e., TPU granules).

Based on a total weight of the reaction mixture being 100 parts by weight, an amount of the isocyanate material is between 20 parts by weight and 60 parts by weight, an amount of the polyol material is between 20 parts by weight and 60 parts by weight, an amount of the chain extender is between 5 parts by weight and 20 parts by weight, an amount of the anti-hydrolysis agent is between 0.1 parts by weight and 1 part by weight, an amount of the chain terminator is between 0.01 parts by weight and 0.3 parts by weight, an amount of the ultraviolet absorber is between 0.1 parts by weight and 0.5 parts by weight, and an amount of the light stabilizer is between 0.1 parts by weight and 0.5 parts by weight, but the present disclosure is not limited thereto.

### Experimental Data and Test Results

Hereinafter, Exemplary Examples 1-4 and Comparative Examples 1-2 are used to describe the contents of the present disclosure in detail. However, the following examples are only provided to aid in understanding of the present disclosure, and are not to be construed as limiting the scope of the present disclosure. Experimental conditions and test results of Exemplary Examples 1-4 and Comparative Examples 1-2 are shown in Table 1. Exemplary Examples 1-4 are exemplary embodiments of the present disclosure. Comparative Examples 1-2 are control groups, which are used to prove that Exemplary Examples 1-4 have better technical effects.

In Exemplary Example 1, 40 grams of an isocyanate material (including 94% of H₁₂MDI and 6% of HDI), 39 grams of a polyol material (i.e., a polycaprolactone polyol having a number average molecular weight Mn of 2,000 g/mol), 11.4 grams of a chain extender (i.e., 1,4-BG), 0.3 grams of an anti-hydrolysis agent (i.e., carbodiimide), 0.1 grams of a chain terminator (i.e., stearyl alcohol), 0.3 grams of an ultraviolet absorber (i.e., UV 328), and 0.3 grams of a light stabilizer (i.e., LS770) are introduced into a twin-screw extruder to perform a polymerization reaction. Here, the chain terminator is introduced into a rearward section of the twin-screw extruder to terminate the polymerization reaction and finally form a thermoplastic polyurethane resin. The thermoplastic polyurethane resin is then pelletized in a water phase environment, so as to form a plurality of TPU granules. In addition, a NCO/OH equivalent ratio of the isocyanate material relative to the polyol material is 1.012, and a weight average molecular weight (Mw) of the thermoplastic polyurethane resin (i.e., the TPU granules) is 185,000 g/mol. Furthermore, a melt flow index (MI) of the thermoplastic polyurethane resin (i.e., the TPU granules) is 2.5 g/10 min measured at 200° C.

In Exemplary Example 2, 40.2 grams of an isocyanate material (including 86.2% of H₁₂MDI and 13.8% of HDI), 39.4 grams of a polyol material (i.e., a polycaprolactone polyol having a number average molecular weight Mn of 2,000 g/mol), 11.5 grams of a chain extender (i.e., 1,4-BG), 0.5 grams of an anti-hydrolysis agent (i.e., carbodiimide), 0.1 grams of a chain terminator (i.e., stearyl alcohol), 0.3 grams of an ultraviolet absorber (i.e., UV 328), and 0.3 grams of a light stabilizer (i.e., LS770) are introduced into a twin-screw extruder to perform a polymerization reaction. Here, the chain terminator is introduced into a rearward section of the twin-screw extruder to terminate the polymerization reaction and finally form a thermoplastic polyurethane resin. The thermoplastic polyurethane resin is then pelletized in a water phase environment, so as to form a plurality of TPU granules. In addition, a NCO/OH equivalent ratio of the isocyanate material relative to the polyol material is 1.015, and a weight average molecular weight (Mw) of the thermoplastic polyurethane resin (i.e., the TPU granules) is 223,000 g/mol. Furthermore, a melt flow index (MI) of the thermoplastic polyurethane resin (i.e., the TPU granules) is 3.1 g/10 min measured at 200° C.

In Exemplary Example 3, 40.5 grams of an isocyanate material (including 91.4% of H₁₂MDI and 8.6% of IPDI), 38.6 grams of a polyol material (i.e., a polycaprolactone polyol having a number average molecular weight Mn of 2,000 g/mol), 11.3 grams of a chain extender (i.e., 1,4-BG), 0.5 grams of an anti-hydrolysis agent (i.e., carbodiimide), 0.1 grams of a chain terminator (i.e., stearyl alcohol), 0.3 grams of an ultraviolet absorber (i.e., UV 328), and 0.3 grams of a light stabilizer (i.e., LS770) are introduced into a twin-screw extruder to perform a polymerization reaction. Here, the chain terminator is introduced into a rearward section of the twin-screw extruder to terminate the polymerization reaction and finally form a thermoplastic polyurethane resin. The thermoplastic polyurethane resin is then pelletized in a water phase environment, so as to form a plurality of TPU granules. In addition, a NCO/OH equivalent ratio of the isocyanate material relative to the polyol material is 1.015, and a weight average molecular weight (Mw) of the thermoplastic polyurethane resin (i.e., the TPU granules) is 219,000 g/mol. Furthermore, a melt flow index (MI) of the thermoplastic polyurethane resin (i.e., the TPU granules) is 2.4 g/10 min measured at 200° C.

In Exemplary Example 4, 40.5 grams of an isocyanate material (including 91.4% of H₁₂MDI and 8.6% of IPDI), 38.9 grams of a polyol material (i.e., a polycaprolactone polyol having a number average molecular weight Mn of 2,000 g/mol), 11.3 grams of a chain extender (i.e., 1,4-BG), 0.5 grams of an anti-hydrolysis agent (i.e., carbodiimide), 0.1 grams of a chain terminator (i.e., stearyl alcohol), 0.3 grams of an ultraviolet absorber (i.e., UV 328), and 0.3 grams of a light stabilizer (i.e., LS770) are introduced into a twin-screw extruder to perform a polymerization reaction. Here, the chain terminator is introduced into a rearward section of the twin-screw extruder to terminate the polymerization reaction and finally form a thermoplastic polyurethane resin. The thermoplastic polyurethane resin is then pelletized in a water phase environment, so as to form a plurality of TPU granules. In addition, a NCO/OH equivalent ratio of the isocyanate material relative to the polyol material is 1.015. The thermoplastic polyurethane resin (i.e., the TPU granules) has a weight average molecular weight (Mw) of 206,000 g/mol and a melt flow index (MI) of 1.6 g/10 min measured at 200° C.

In Comparative Example 1, 40.8 grams of an isocyanate material (including 100% of MDI), 48 grams of a polyol material (i.e., a polycaprolactone polyol having a number average molecular weight Mn of 2,000 g/mol), 11.2 grams of a chain extender (i.e., 1,4-BG), 0.5 grams of an anti-hydrolysis agent (i.e., carbodiimide), 0.1 grams of a chain terminator (i.e., stearyl alcohol), 0.3 grams of an ultraviolet absorber (i.e., UV 328), and 0.3 grams of a light stabilizer (i.e., LS770) are introduced into a twin-screw extruder to perform a polymerization reaction. Here, the chain terminator is introduced into a rearward section of the twin-screw extruder to terminate the polymerization reaction and finally form a thermoplastic polyurethane resin. The thermoplastic polyurethane resin is then pelletized in a water phase environment, so as to form a plurality of TPU granules. In addition, a NCO/OH equivalent ratio of the isocyanate material relative to the polyol material is 1.012. The thermoplastic polyurethane resin (i.e., the TPU granules) has a weight average molecular weight (Mw) of 206,000 g/mol and a melt flow index (MI) of 4.0 g/10 min measured at 200° C.

In Comparative Example 2, 47.7 grams of an isocyanate material (including 100% of MDI), 39.9 grams of a polyol material (i.e., a polyether polyol having a number average molecular weight Mn of 1,800 g/mol), 12.4 grams of a chain extender (i.e., 1,4-BG), 0.2 grams of an anti-hydrolysis agent (i.e., carbodiimide), 0.1 grams of a chain terminator (i.e., stearyl alcohol), 0.3 grams of an ultraviolet absorber (i.e., UV 328), and 0.3 grams of a light stabilizer (i.e., LS770) are introduced into a twin-screw extruder to perform a polymerization reaction. Here, the chain terminator is introduced into a rearward section of the twin-screw extruder to terminate the polymerization reaction and finally form a thermoplastic polyurethane resin. The thermoplastic polyurethane resin is then pelletized in a water phase environment, so as to form a plurality of TPU granules. Furthermore, a NCO/OH equivalent ratio of the isocyanate material relative to the polyol material is 1.015. The thermoplastic polyurethane resin (i.e., the TPU granules) has a weight average molecular weight (Mw) of 206,000 g/mol and a melt flow index (MI) of 2.9 g/10 min at 200° C.

Then, the thermoplastic polyurethane resins prepared in Exemplary Examples 1-4 and Comparative Examples 1-2 are tested to obtain physical and chemical properties, such as processability (a coating appearance), visible light transmittance (%), weather resistance (a color difference value ΔE of a QUV test), and hydrolysis resistance (a tensile strength maintenance rate %). Test methods are described as follows, and test results are summarized in Table 1.

The test of processability is to observe whether or not there are coarse grains or crystal points present on an appearance of a film formed by coating the TPU granules on an object (i.e., a car shell) through the extruder (T-die). If the appearance of the film has no coarse grains or crystal points, the TPU granules are evaluated as having good processability.

The test of light transmittance is to measure a TPU injection-molded test piece having a thickness of 2 mm through a light transmittance meter, and to record a visible light transmittance (%) of the test piece.

The test of weather resistance is to irradiate a TPU thermo-compression-molded test piece having a thickness of 0.2 mm by a light source of QUV 340 nm for 1,000 hours, and to analyze ΔE*ab (a CIE color difference value) of the test piece.

The test of hydrolysis resistance is to place a TPU thermo-compression-molded test piece having a thickness of 0.2 mm in an environment where a temperature is 60° C. and a relative humidity is 90 RH % for 28 days, and to measure a tensile strength maintenance rate of the test piece.

TABLE 1
Experimental Conditions and Test Results]

| | | Exemplary | Exemplary | Exemplary | Exemplary |
|---|---|---|---|---|---|
| | Items | Example 1 | Example 2 | Example 3 | Example 4 |
| Preparation | amount of | 40 | 40.2 | 40.5 | 40.5 |
| conditions | isocyanate | | | | |
| of | material | | | | |
| [symbol] | (grams) | | | | |
| | material type | 94% | 86.2% | 91.4% | 91.4% |
| | and weight | H₁₂MDI | H₁₂MDI | H₁₂MDI | H₁₂MDI |
| | ratio of | and | and | and | and |
| | isocyanate | 6% | 13.8% | 8.6% | 8.6% |
| | material | HDI | HDI | IPDI | IPDI |
| | amount of | 39 | 39.4 | 38.6 | 38.9 |
| | polyol material | | | | |
| | (grams) | | | | |
| | material type | poly- | poly- | poly- | poly- |
| | of polyol | capro- | capro- | capro- | capro- |
| | material | lactone | lactone | lactone | lactone |
| | | (PCL) | (PCL) | (PCL) | (PCL) |
| | | polyol | polyol | polyol | polyol |
| | molecular | 2,000 | 2,000 | 2,000 | 2,000 |
| | weight of | | | | |
| | polyol | | | | |
| | Mn (g/mol) | | | | |
| | amount of | 11.4 | 11.5 | 11.3 | 11.3 |
| | chain extender | | | | |
| | (grams) | | | | |
| | material type | 1,4-BG | 1,4-BG | 1,4-BG | 1,4-BG |
| | of | | | | |
| | chain extender | | | | |
| | amount of | 0.3 | 0.5 | 0.5 | 0.5 |
| | anti-hydrolysis | | | | |
| | agent (grams) | | | | |
| | material type | carbodiimide | carbodiimide | carbodiimide | carbodiimide |
| | of | | | | |
| | anti-hydrolysis | | | | |
| | agent | | | | |
| | amount of | 0.1 | 0.1 | 0.1 | 0.1 |
| | chain | | | | |
| | terminator | | | | |
| | (grams) | | | | |
| | material type | stearyl | stearyl | stearyl | stearyl |
| | of | alcohol | alcohol | alcohol | alcohol |
| | chain | | | | |
| | terminator | | | | |
| | amount of | 0.3 | 0.3 | 0.3 | 0.3 |
| | ultraviolet | | | | |
| | absorber | | | | |
| | (grams) | | | | |
| | material type | UV328 | UV328 | UV328 | UV328 |
| | of | | | | |
| | ultraviolet | | | | |
| | absorber | | | | |
| | amount of | 0.3 | 0.3 | 0.3 | 0.3 |
| | light stabilizer | | | | |
| | (grams) | | | | |
| | material type | LS770 | LS770 | LS770 | LS770 |
| | of | | | | |
| | light stabilizer | | | | |
| | NCO/OH | 1.012 | 1.015 | 1.015 | 1.015 |
| | equivalent ratio | | | | |
| | Mw of TPU | 185,000 | 223,000 | 219,000 | 206,000 |
| | granules | | | | |
| | (g/mol) | | | | |
| | MI of TPU | 2.5 | 3.1 | 2.4 | 1.6 |
| | granules | | | | |
| | (g/10 min) | | | | |
| | measured at | | | | |
| | 200° C. | | | | |
| physical | processability | no coarse | no coarse | no coarse | no coarse |
| and | (a coating | grains and | grains and | grains and | grains and |
| [symbol] | appearance) | no crystal | no crystal | no crystal | no crystal |
| | | points | points | points | points |
| | visible light | 91.5 | 92.1 | 91.8 | 92.0 |
| | transmittance | | | | |
| | (%) | | | | |
| | weather | 1.09 | 0.98 | 1.14 | 1.34 |
| | resistance (a | | | | |
| | color | | | | |
| | difference | | | | |
| | value ΔE of a | | | | |
| | QUV test) | | | | |
| | hydrolysis | 82.3 | 81.9 | 80.3 | 81.1 |
| | resistance | | | | |
| | (a tensile | | | | |
| | strength | | | | |
| | maintenance | | | | |
| | rate %) | | | | |

| | | Comparative | Comparative |
|---|---|---|---|
| | Items | Example 1 | Example 2 |
| Preparation | amount of | 40.8 | 47.7 |
| conditions | isocyanate material | | |
| of | (grams) | | |
| TPU | material type and | 100% MDI | 100% MDI |
| granules | weight ratio of | | |
| | isocyanate material | | |
| | amount of | 48 | 39.9 |
| | polyol material | | |
| | (grams) | | |
| | material type of | poly-capro- | polyether polyol |
| | polyol material | lactone (PCL) | |
| | | polyol | |
| | molecular weight of | 2,000 | 1,800 |
| | polyol | | |
| | Mn (g/mol) | | |
| | amount of | 11.2 | 12.4 |
| | chain extender | | |
| | (grams) | | |
| | material type of | 1,4-BG | 1,4-BG |
| | chain extender | | |
| | amount of | 0.5 | 0.2 |
| | anti-hydrolysis agent | | |
| | (grams) | | |
| | material type of | carbodiimide | carbodiimide |
| | anti-hydrolysis agent | | |
| | amount of | 0.1 | 0.1 |
| | chain terminator | | |
| | (grams) | | |
| | material type of | stearyl alcohol | stearyl alcohol |
| | chain terminator | | |
| | amount of ultraviolet | 0.3 | 0.3 |
| | absorber (grams) | | |
| | material type of | UV328 | UV328 |
| | ultraviolet absorber | | |
| | amount of | 0.3 | 0.3 |
| | light stabilizer | | |
| | (grams) | | |
| | material type of | LS770 | LS770 |
| | light stabilizer | | |
| | NCO/OH | 1.012 | 1.015 |
| | equivalent ratio | | |
| | Mw of TPU granules | 206,000 | 206,000 |
| | (g/mol) | | |
| | MI of TPU granules | 4.0 | 2.9 |
| | (g/10 min) measured at | | |
| | 200° C. | | |
| test | processability | no coarse grains | no coarse grains |
| results | (a coating appearance) | and no crystal | and no crystal |
| of | | points | points |
| physical | visible light | 89.1 | 88.9 |
| and | transmittance (%) | | |
| chemical | weather resistance | 20.6 | 26.4 |
| properties | (a color difference value | | |
| | ΔE of a QUV test) | | |
| | hydrolysis resistance | 72.3 | 86.5 |
| | (a tensile strength | | |
| | maintenance rate %) | | |

[symbol]

indicates data missing or illegible when filed

### [Discussion of Test Results]

It can be observed from the above test results that in each of Exemplary Examples 1-4, after the TPU granules are coated by the extruder (T-die) to form the film, the appearance of the film has no coarse grains or crystal points, so that the TPU granules have good processability. The TPU injection-molded test piece having the thickness of 2 mm has the visible light transmittance of between 91.5% and 92.1%, which indicates that the TPU resin material has good light transmittance. After being irradiated by the light source of QUV 340 nm for 1,000 hours, the ΔE color difference value of the TPU thermo-compression-molded test piece having the thickness of 0.2 mm is between 0.98 and 1.34, which indicates that the TPU resin material is weather resistant and has the property of not easily yellowing over time. The TPU thermo-compression-molded test piece having the thickness of 0.2 mm is stored in the environment where the temperature is 60° C. and the relative humidity is 90 RH % for 28 days, and the tensile strength maintenance rate of the test piece is between 80.3% and 82.3%, which indicates that the TPU resin material has good hydrolysis resistance.

Overall, the TPU granules of Exemplary Examples 1-4 adopt H₁₂MDI as the main isocyanate material together with a small amount of HDI or IPDI, and polycaprolactone (PCL) polyol is further incorporated for synthesis, so that the light transmittance of the TPU resin material can reach more than 90%, and the TPU resin material can have improved weather resistance (yellowing resistance) and hydrolysis resistance.

The isocyanate material used for synthesizing the TPU granules in each of Comparative Examples 1-2 is aromatic MDI, and the test result of ΔE color difference is between 20.6 and 26.4. This indicates that the weather resistance of Comparative Examples 1-2 is poorer than that of Exemplary Examples 1-4, and yellowing is more likely to occur over time. Furthermore, the hydrolysis resistance of the TPU resin material of Comparative Example 1 is inferior to that of Exemplary Examples 1-4. The TPU resin material of Comparative Example 2 is synthesized by polyether polyol, and the light transmittance (less than 90%) of Comparative Example 2 is slightly lower than that of Exemplary Examples 1-4.

### Beneficial Effects of the Embodiments

In conclusion, in the thermoplastic polyurethane resin used for preparing the car wrap film of the present disclosure, through material selection and material cooperation of the isocyanate material and the polyol material, technical inadequacies of a conventional TPU material (such as yellowing over time, degradation of physical properties due to hydrolysis, and occurrence of crystal points and poor transparency after coating) can be effectively improved. Accordingly, the quality of the car wrap film can be enhanced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A thermoplastic polyurethane resin used for preparing a car wrap film, characterized in that the thermoplastic polyurethane resin is formed from a reaction mixture through a polymerization reaction, and the reaction mixture includes:
an isocyanate material, wherein a chemical structure of the isocyanate material does not have any benzene ring, and the isocyanate material is selected from the group consisting of 4,4′-diisocyanato di-cyclo-hexyl-methane (H₁₂MDI), hexa-methylene di-isocyanate (HDI), and iso-phorone di-isocyanate (IPDI);
a polyol material, wherein the polyol material is selected from the group consisting of polycaprolactone polyol and polyether polyol; and
a chain extender being a glycol chain extender.

2. The thermoplastic polyurethane resin according to claim 1, wherein the isocyanate material includes a first isocyanate component and a second isocyanate component, the first isocyanate component is 4,4′-diisocyanato dicyclohexylmethane, and the second isocyanate component is at least one of hexamethylene diisocyanate and isophorone diisocyanate.

3. The thermoplastic polyurethane resin according to claim 2, wherein, based on a total weight of the first isocyanate component and the second isocyanate component being 100%, a first weight ratio of the first isocyanate component ranges from 70% to 98%, and a second weight ratio of the second isocyanate component ranges from 2% to 30%.

4. The thermoplastic polyurethane resin according to claim 1, wherein the polyol material is further defined as the polycaprolactone polyol, and the polycaprolactone polyol is formed by polymerizing low molecule diols and caprolactone monomers; wherein each of the low molecule diols is a diol having a carbon number of from C2 to C8.

5. The thermoplastic polyurethane resin according to claim 4, wherein each of the low molecule diols is 1,6-hexanediol, and a number average molecular weight (Mn) of the polyol material is between 1,000 g/mole and 5,000 g/mole; wherein the chain extender is 1,4-butanediol (14-BG).

6. The thermoplastic polyurethane resin according to claim 1, wherein an NCO/OH equivalent ratio of an isocyanate group (—NCO) of the isocyanate material relative to a hydroxyl group (—OH) of the polyol material is between 0.998 and 1.015.

7. The thermoplastic polyurethane resin according to claim 1, wherein the reaction mixture further includes: an anti-hydrolysis agent and a chain terminator, the anti-hydrolysis agent is carbodiimide, and the chain terminator is a long-chain fatty alcohol having a carbon number of from C12 to C18.

8. The thermoplastic polyurethane resin according to claim 7, wherein the chain terminator is selected from the group consisting of stearyl alcohol, lauryl alcohol, and oleic alcohol.

9. The thermoplastic polyurethane resin according to claim 7, wherein, based on a total weight of the reaction mixture being 100 parts by weight, an amount of the isocyanate material is between 20 parts by weight and 60 parts by weight, an amount of the polyol material is between 20 parts by weight and 60 parts by weight, an amount of the chain extender is between 5 parts by weight and 20 parts by weight, an amount of the anti-hydrolysis agent is between 0.1 parts by weight and 1 part by weight, and an amount of the chain terminator is between 0.01 parts by weight and 0.3 parts by weight.

10. The thermoplastic polyurethane resin according to claim 1, wherein the thermoplastic polyurethane resin has a melt flow index (MI) of between 1 g/10 min and 5 g/10 min measured at 200° C.
